(19) United States
(12) Patent Application Publication
(10) Pub. No.: US 2026/0135306 A1
(43) Pub. Date: May 14, 2026

(54) ELECTRICAL TERMINAL

(71) Applicant: TE Connectivity Solutions GmbH, Schaffhausen (CH)

(72) Inventors: Romain VILLARD, Saint Priest (FR); Geoffrey MOINE, Saint Priest (FR)

(21) Appl. No.: 19/384,420

(22) Filed: Nov. 10, 2025

(30) Foreign Application Priority Data
Nov. 11, 2024 (EP) 24212101.0

(51) Int. Cl. H01R 4/2433; H01R 9/24; H01R 9/26; H01R 11/01; H01R 43/01

(52) U.S. Cl. CPC H01R 4/2433; H01R 9/2416; H01R 9/2608; H01R 11/01; H01R 43/01

(57) ABSTRACT

An electrical terminal, in particular an IDC-terminal, with a housing, a contacting base positioned inside the housing and at least one contacting unit for contacting a conductor, wherein the contacting unit comprises a contacting body with a blade-structure comprising at least one blade with at least one cutting edge, wherein the contacting unit is movable inside the housing along a contacting direction between an neutral position and a contacting position, wherein the housing defines an accommodation space between the blade-structure and the conducting base, and wherein by moving the contacting unit from the neutral position to the contacting position a distance between the blade-structure and the contacting unit is reducible, and wherein in the contacting position the blade-structure is arranged to contact the contacting base.

### CROSS REFERENCE TO RELATED APPLICATIONS

This application claims the benefit of EP Application No. 24212101.0, filed 11 Nov. 2024, the subject matter of which is herein incorporated by reference in its entirety.

### BACKGROUND OF THE INVENTION

The subject matter relates to an electrical terminal, in particular to an IDC-terminal.

Electrical terminals and in particular IDC-terminals are known from state of the art.

An objective of the subject matter herein is to provide an improved electrical terminal, an improved electrical terminal system and an improved method for assembling an electrical terminal system.

The objective may be solved by the electrical terminal, the system and the method of the independent claims. Embodiments are subject of the dependent claims.

### BRIEF DESCRIPTION OF THE INVENTION

According to an embodiment, an electrical terminal, in particular an IDC-terminal, with a housing, a contacting base positioned inside the housing and at least one contacting unit is provided, wherein the contacting unit comprises a contacting body with a blade-structure comprising at least one blade with at least one cutting edge, wherein the contacting unit is movable inside the housing along a contacting direction between a neutral position and a contacting position, wherein the housing defines an accommodation space between the blade-structure and the conducting base, and wherein by moving the contacting unit from the neutral position to the contacting position a distance between the blade-structure and the contacting unit is reducible, and wherein in the contacting position the blade-structure is arranged to contact the contacting base.

This can achieve the technical advantage that an improved electrical terminal, in particular an improved IDC-terminal, can be provided. By means of the contacting unit, which is movable with respect to the housing between a neutral position, in which a conductor can be inserted into the terminal, and a contacting position, in which the conductor can be contacted to a contacting base, an easy contacting of the conductor can be achieved by pushing the contacting unit from the neutral position into the contacting position. The contacting unit comprises a blade-structure with at least one blade having a cutting edge.

By moving the contacting unit from the neutral position to the contacting position a distance between the blade-structure and the conducting base is reduced. This reduction in space between the blade-structure and the conducting base allows the blade of the blade-structure to cut a conductor insulation of a conductor positioned in the accommodation space between the blade-structure and the contacting base.

By cutting the conductor insulation, the blade of the blade-structure contacts the conductor body of the conductor. Further, in the contacting position, the blade-structure of the contacting unit, which cut the conductor insulation and contacted the conductor body, further contacts the contacting base, when the contacting unit is positioned in the contacting position. Thus, via the blade-structure of the contacting unit, an electrical contact can be realized between the conductor body of the conductor placed in the accommodation space and the contacting base of the terminal.

Thus, via the contacting base, the conductor inserted into the terminal and contacted via the contacting unit can be contacted to a further component, for example, a further conductor. The electrical terminal therefore provides an easy way to contact conductors by means of IDC contacting, as for contacting the conductor, the conductor only has to be inserted into the housing of the terminal and positioned in the accommodation space and the contacting unit has to be pushed from the neutral position into the contacting position.

Further, the electrical terminal provides a robust and efficient electrical contacting of the to be contacted conductor. In addition, the electrical terminal comprises a small number of parts and therefore is easy to be manufactured.

The electrical terminal can be connected to a DIN rail.

In the application IDC stands for Insulation-Displacement-Contact.

According to an embodiment, the blade-structure comprises a forklike structure with two blades and an opening facing the contacting unit, wherein each of the blades has a cutting edge, and wherein the cutting edges of the two blades are facing each other and/or are facing the contacting base.

This can achieve the technical advantage that due to the forklike structure with two blades having cutting edges facing each other, the blade-structure of the contacting unit can provide a robust and efficient electrical contacting of the inserted conductor. By means of the two blades, the conductor inserted into the terminal is cut by each of the two blades when the contacting unit is positioned in the contacting position.

Thus, the conductor insulation is cut on two separate positions and the contacting body is contacted via each of the two blades of the blade-structure. This provides a robust and efficient electrical contacting.

According to an embodiment, the two blades of the blade-structure are arranged to provide a clamping force.

This can achieve the technical advantage that by means of the clamping force of the blade structure the conductor body can be held by the two blades of the blade-structure when the contacting unit is positioned in the contacting position. This leads to a robust electrical contacting of the conductor.

According to an embodiment, a tip portion of the blade has a chamfered face.

This can achieve the technical advantage that via the chamfered faces of the tip portions of the blades, an easy cutting of the conductor insulation and easy contacting of the conductor by means of the blade-structure can be achieved.

According to an embodiment, the contacting base has a platelike shape with at least one contacting recess, and wherein in the contacting position the blade-structure protrudes through the recess and contacts the contacting base.

This can achieve the technical advantage that via the contacting recesses, a robust electrical and mechanical contacting between the blades of the blade-structure and the contacting base when the contacting unit is positioned in the contacting position can be achieved. For this, the tip portions of the blades of the blade-structure protrude through the contacting recesses of the contacting base. This leads to a robust contact between the blade-structure of the contacting unit and the contacting base.

According to an embodiment, the contacting body comprises an actuating member protruding from the housing, wherein by means of the actuating member the contacting unit can be pushed from the neutral position to the contacting position.

This can achieve the technical advantage that by means of the actuating member protruding from the housing of the electrical terminal, the contacting unit can easily be moved from the neutral position to the contacting position via a user of the electrical terminal. As the actuating member is positioned outside the housing, the user only has to push the actuating member in contacting direction and by this push the contacting unit and the respective blade-structure from the neutral position to the contacting position. This allows for an easy handling of the electrical terminal and an easy way to contact conductors by means of the electrical terminal.

According to an embodiment, the contacting body is made of a plastic material, and/or the blade-structure and the contact base are made of a metal material by means of a punching process.

This can achieve the technical advantage that the contacting unit and the contacting base are easy to manufacture.

According to an embodiment, the housing and/or the contacting unit comprises a releasing element arranged to release the contacting unit from the contacting position.

This can achieve the technical advantage that by means of the releasing elements, the contacting unit can be released from the contacting position and be reset to the neutral position. As the contacting unit is released from the contacting position, the blades of the blade-structure are released from the conductor positioned in the insertion position. Thus, the conductor can be removed from the terminal. As a result, the terminal can be reused for conducting a different conductor.

According to an embodiment, the contacting unit is lockable in the neutral position and/or the contacting position by means of a snap connection between the contacting unit and the housing.

This can achieve the technical advantage that via the snap connection, a robust positioning of the contacting unit in the neutral position and/or in the contacting position can be achieved. By robustly positioning the contacting unit in the neutral position and/or the contacting position, the handling of the terminal is improved. In particular, by robustly locking the contacting unit in the contacting position via the snap connection, the robustness of the electrical contacting of the conductor is further enhanced.

By means of the snap connection, the contacting is held firmly in the contacting position, such that even through intense vibration of the entire terminal, the electrical contacting of the conductor by means of the contacting unit cannot be loosened.

According to an embodiment, the terminal comprises two contacting units, wherein each of the two contacting units comprises a blade-structure, wherein in the contacting position each blade-structure of the two contacting units is arranged to contact the same contacting base.

This can achieve the technical advantage that via the two contacting units, two different conductors can be contacted with each other. For this, the terminal comprises two contacting units and two insertion openings. Via the two insertion openings, two individual conductors can be inserted into the terminal and positioned in respective insertion positions. The two individual conductors positioned in the accommodation space are each positioned adjacent to the same contacting base.

By pushing the two individual contacting units from the neutral position into the contacting position, the two blade-structures of the two contacting units individually cut the conducting insulations and contact the contacting bodies of the two conductors and further contact the same contacting base when positioned in the contacting position. Thus, via the contacting base, an electrical contact is achieved between the two individual conductors. This way, an easy and robust way of electrical contacting two individual conductors by means of IDC-contacting can be achieved.

According to an embodiment, the two contacting units are positioned opposite to each other.

This can achieve the technical advantage that by positioning the contacting units on opposite sides of each other, a space saving design of the electrical terminal can be achieved.

According to an embodiment, the housing comprises at least one insertion opening with a guiding element, and/or the housing and/or the contacting base comprises an insertion stop defining an insertion distance between the insertion opening and the insertion stop.

This can achieve the technical advantage that via the insertion openings and the respective guiding elements provided in the housing, the to be contacted conductors can easily be positioned in the insertion position inside the housing of the terminal. Further, via the insertion stop formed in the housing and/or the contacting base, an extensive insertion of the conductor into the housing, in which the conductor extends beyond the insertion position, can be avoided.

According to an aspect, a terminal system with an electrical terminal according to any of the preceding embodiments and at least one conductor is provided, wherein the at least one conductor is inserted into the housing and positioned adjacent to the contacting base of the terminal, wherein the contacting unit is positioned in the contacting position, wherein the insulation of the conductor is cut and the conductor body of the conductor is contacted by the at least one cutting edge of the at least one edge of the blade-structure, wherein the contacting base is contacted by the blade-structure of the contacting unit, and wherein an electrical contact between the conductor body of the conductor and the contacting base is provided by means of the at least one blade of the blade-structure.

This can achieve the technical advantage that an improved terminal system with an electrical terminal with the abovementioned technical advantages can be provided.

According to an embodiment, a further conductor is inserted into the housing of the terminal and positioned adjacent to the contacting base of the terminal, wherein the further contacting unit is positioned in the contacting position, wherein the insulation of the further conductor is cut and the conductor body of the further conductor is contacted by the at least one cutting edge of the at least one blade of the blade-structure of the further contacting unit, wherein the contacting base is contacted by the at least one blade of the further contacting unit, wherein an electrical contact between the conductor body of the further conductor and the contacting base is provided by means of the at least one blade of the blade-structure of the further contacting unit, and wherein an electrical contact between the conductor and the further conductor is provided by means of the contacting base.

This can achieve the technical advantage that via the terminal system two individual conductors can be contacted to each other by means of the electrical terminal.

According to an aspect, a method of assembling a terminal system is provided, comprising:
Providing an electrical terminal according to any of the preceding embodiments and at least one conductor;
Positioning the at least one contacting unit of the terminal in the neutral position;
Inserting the at least one conductor into the housing of the electrical terminal and positioning an end portion of the conductor adjacent to the contacting base of the terminal; and
Pushing the at least one contacting unit from the neutral position to the contacting position, wherein in the contacting position the insulation of the conductor is cut by the at least one cutting edge of the at least one blade of the blade-structure of the contacting unit and the conductor body of the at least one conductor is contacted by the cutting edge of the blade of the blade-structure and the contacting base is contacted by the at least one blade of the blade-structure of the contacting unit.

This can achieve the technical advantage that an improved method for electrically contacting individual conductors by means of IDC-contacting can be achieved.

### BRIEF DESCRIPTION OF THE DRAWINGS

The invention is described with respect to the figures. In the figures it is illustrated in:

FIG. 1 a schematic illustration of an electrical terminal system with an electrical terminal according to an embodiment,

FIGS. 2a, 2b and 2c are schematic sectional views of the electrical terminal according to an embodiment,

FIG. 3 a schematic sectional view of a contacting unit of the electrical terminal in a contacting position according to an embodiment,

FIG. 4 a schematic illustration of the terminal system with an electrical terminal according to another embodiment,

FIG. 5 a schematic sectional view of the terminal system with an electrical terminal according to another embodiment,

FIG. 6 a schematic illustration of the contacting units of the electrical terminal according to another embodiment,

FIG. 7 another schematic illustration of the contacting units of the electrical terminal according to another embodiment, and

FIG. 8 another schematic illustration of the contacting units of the electrical terminal according to another embodiment.

### DETAILED DESCRIPTION OF THE INVENTION

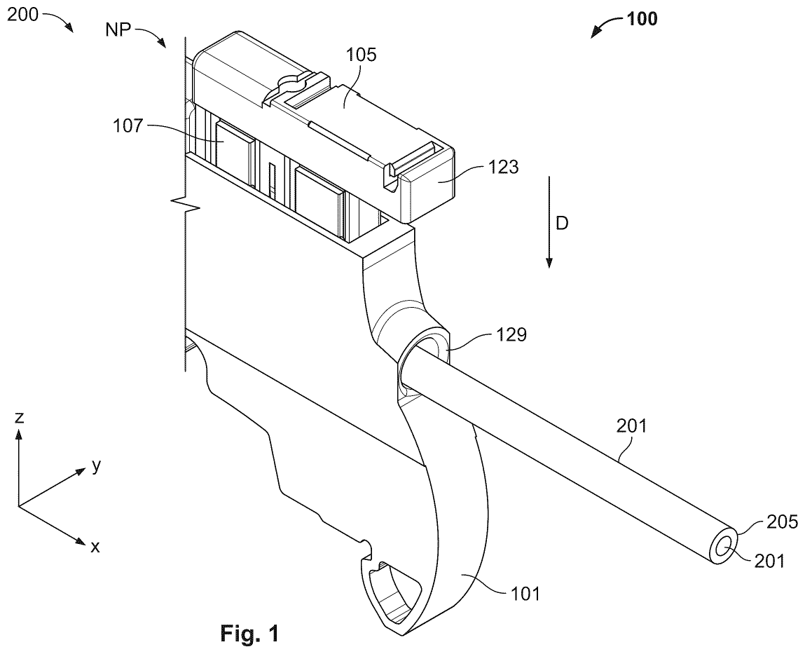

FIG. 1 shows a schematic illustration of an electrical terminal system 200 with an electrical terminal 100 according to an embodiment.

In the shown embodiment, the electrical terminal 100 comprises a housing 101 and a contacting unit 105. The contacting unit 105 comprises a contacting body 107 with an actuating member 123. The actuating member 123 is positioned outside the housing 101. The contacting unit 105 is movable relative to the housing 101 between a neutral position NP and a contacting position CP. In FIG. 1, the shown contacting unit 105 is positioned in the neutral position NP.

With the contacting unit 105 positioned in the neutral position NP, a conductor 201 can be inserted into the housing 101 via an insertion opening 129 and can be positioned at least partially inside the housing 101 in an insertion position IP.

In FIG. 1 not shown is a contacting base 103, that is positioned inside the housing 101. Further, in FIG. 1 not shown is a blade-structure 109 with at least one blade 111, that is part of the contacting body 107 of the contacting unit 105.

By pushing the contacting unit 105 from the neutral position NP in the contacting direction D into the contacting position CP, a distance A1 between the blade-structure 109 of the contacting unit 105 and the contacting base 103 can be reduced.

By reducing the distance A1 between the blade-structure 109 of the contacting unit 105 and the contacting base 103 the conductor 201 positioned in the accommodation space 115 between the blade-structure 109 of the contacting unit 105 and the contacting base 103 can be contacted by the blade-structure 109 contacting unit 105.

By pushing the contacting unit 105 from the neutral position NP to the contacting position CP, the at least one blade 111 of the blade-structure 109 of the contacting unit 105 cuts a conductor insulation 205 of the conductor 201 positioned in the insertion position IP and contacts a conductor body 203 of the conductor 201.

The blade-structure 109 further contacts the contacting base 103 when the contacting unit 105 is positioned in the contacting position CP.

This way, an electrical contact between the conductor body 203 of the conductor 201 and the contacting base 103 of the terminal 100 is achieved by means of the blade 111 of the blade-structure 109 of the contacting unit 105.

By connecting the contacting base 103 of the terminal 100 to another electrical component, for example, another individual conductor, an electrical contacting of the shown conductor 201 to the other electrical component via the contacting base 103 is achieved by means of an IDC-contacting.

In the shown embodiment, the terminal 100 can serve as an end terminal. The terminal 100 can, for example, be arranged at a DIN rail.

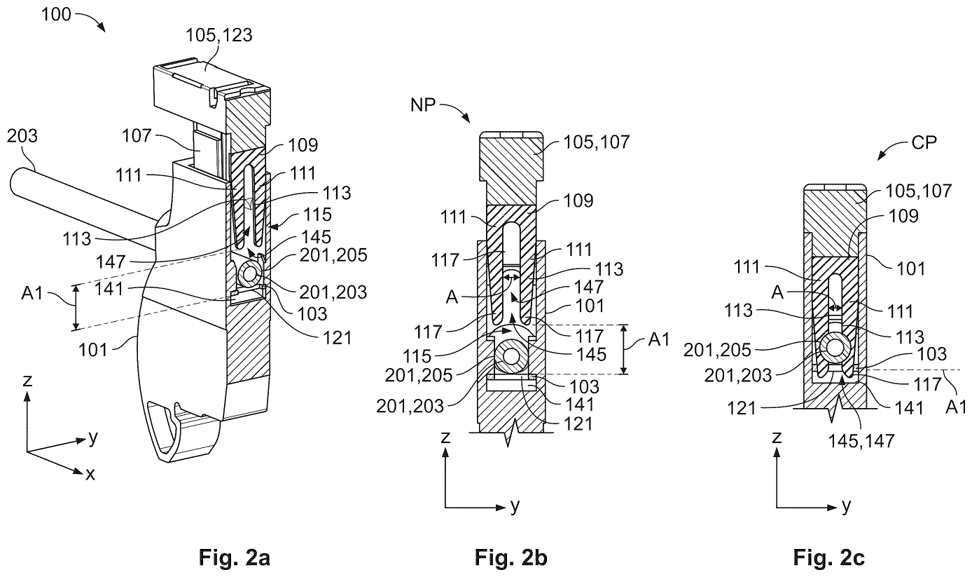

FIG. 2 shows schematic sectional views of the electrical terminal 100 according to an embodiment.

FIGS. 2a, 2b, and 2c show different stages of the process of electrically contacting the conductor 201 by means of the electrical terminal 100 shown in FIG. 1.

FIG. 2a shows a perspective schematic sectional view of the electrical terminal 100. As in FIG. 1, the contacting unit 105 is positioned in the neutral position NP. The contacting unit 105 comprises the contacting body 107 comprising the blade-structure 109. In the shown embodiment, the blade-structure 109 has a forklike shape with two blades 111 separated by a distance A between each other.

The two blades 111 define a space 147 between each other and an opening 145 between tip portions 117 of the blades 111. The opening 145 and the tip portions 117 of the two blades 111 are pointing in direction of the contacting base 103.

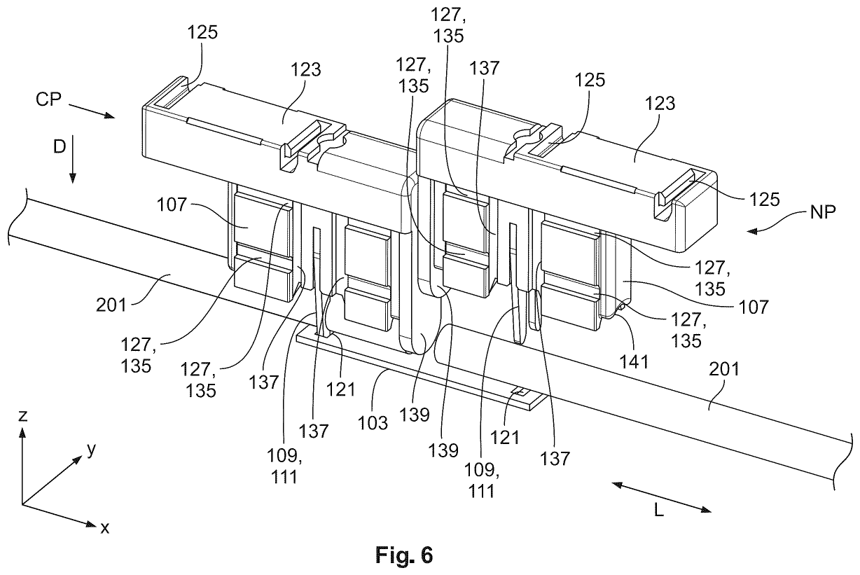

The housing 101 defines an accommodation space 115 to accommodate the to be contacted conductor 201. In FIG. 2a, the conductor 201 is inserted into the housing 101 and positioned in the accommodation space 115 in the insertion position IP. In the insertion position IP, an end section of the conductor 201 is positioned adjacent to the contacting base 103 arranged inside the housing 101. The conductor 210 is positioned between the blade-structure 109 of the contacting unit 105 and the contacting base 103. A more detailed illustration of the contacting base 103 is provided in FIGS. 6 to 8.

The accommodation space 115 is defined by a distance A1 between the blade-structure 109 and the contacting base 103. In the shown embodiment the distance A1 is defined between the tip portions 117 of the blades 111 of the blade-structure 109 and the contacting base 103.

The distance A1 between the blade-structure 109 and the contacting base 103, when the contacting unit 105 is positioned in the neutral position NP, is at least as large as a diameter of the conductor 201.

FIG. 2b shows a frontal sectional view of the terminal 100 in FIG. 2a. As outlined with respect to FIG. 2a, the conductor 201 is positioned in the insertion position IP and is positioned adjacent to the contacting base 103. The conductor 201 comprises a conductor body 203 and a conductor insulation 205.

The blade-structure 109 comprises the two blades 111 facing each other and forming the forklike structure of the blade-structure 109. Each blade 111 comprises a cutting edge 113 with the two cutting edges 113 of the two blades 111 facing each other and being positioned adjacent to each other. The tip portions 117 of the blades 111 point in direction of the conducting base 103.

The cutting edges 113 can be arranged at the inner edges of the blades 111 facing each other. Alternatively or additionally the cutting edges 113 can be arranged at the tip portions 117 of the blades 111 of the blade-structure 109.

The two blades 111 of the blade-structure 109 are separated by a distance A. By means of the separation of the two blades 111 the blade structure is arranged to provide a clamping force.

FIG. 2c is a frontal sectional view of the terminal 100 of the embodiment of FIGS. 2a and 2b. In FIG. 2c, the contacting unit 105 is pushed from the neutral position NP along the contacting direction D into the contacting position CP.

By pushing the contacting unit 105 from the neutral position NP into the contacting position CP, the blade-structure 109 is moved to the contacting position CP and by this is moved into direction of the conductor 201 positioned in the insertion position IP.

By moving the blade-structure 109 to the contacting position CP, the conductor 201 enters the opening 145 between the two blades 111 of the blade-structure 109 and the cutting edges 113 of the two blades 111 of the blade-structure 109 cut the conductor insulation 205 and contact the conductor body 203 of the conductor 201.

As shown in FIG. 2c, the conductor body 203 of the conductor 201 is positioned in the space 147 between the two blades 111 of the forklike blade-structure 109.

Thus, when positioned in the contacting position CP, the distance A1 between the blade-structure 109 and the contacting base 103 is reduced to zero and the blade-structure 109 further contacts the contacting base 103. As illustrated in FIG. 2C, when positioned in the contacting position CP, tip portions 117 of the blades 111 protrude through a contacting recess 121 of the contacting base 103 and extend into a recess space 143 of the housing 101.

The recess space 143 is positioned below the contacting base 103 with respect to the contacting direction D. By extending through the contacting recess 121 of the contacting base 103, outer edges 133 of the blades 111 contact the contacting base 103. By this, the tip portions 117 protrude into the recess space 143 of the housing 101.

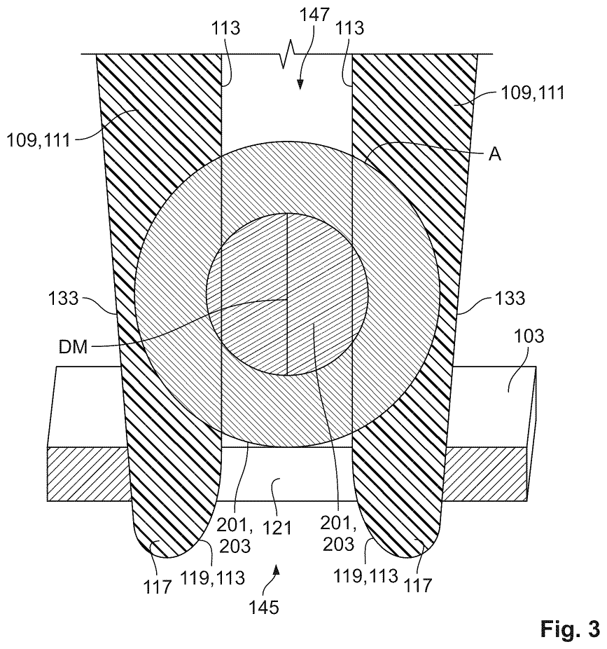

FIG. 3 shows a schematic sectional view of a contacting unit 105 of the electrical terminal 100 in a contacting position according to an embodiment.

FIG. 3 shows a zoomed-in illustration of the blade-structure 109 in the contacting position CP, as illustrated in FIG. 2c.

As shown in FIG. 3, the conductor 201 is positioned in the insertion position IP and therefore is positioned on top of the contacting base 103. By the contacting unit 105 being positioned in the contacting position CP, the distance A1 between the blade-structure 109 and the contacting base 103 is reduced and the cutting edges 113 of the two blades 111 of the blade-structure 109 cut the conductor insulation 205 and contact the conductor body 203 of the conductor 201.

In the contacting position CP the conductor 201 is positioned in the space 147 between the two blades 111.

As shown in FIG. 3, the diameter DM of the conductor body 203 is slightly larger than the clamping space A of the forklike blade-structure 109. As a result, the cutting edges 113 of the two blades 111 also cut the conductor body 203 of the conductor 201. This way, a better electrical contacting between the conductor body 203 and the blades 111 of the blade-structure 109 can be achieved.

As shown in FIG. 3, in the contacting position CP, the tip portions 117 of the blades 111 protrude through the contacting recess 121 of the platelike contacting base 103. This way, the outer edges 133 of the two blades 111 contact the contacting base 103 respectively.

In the shown embodiment, the tip portions 117 of the two blades 111 each comprise a chamfered face 119. Via the chamfered face 119, the cutting of the conductor insulation 205 and/or the conductor body 203 of the conductor 201 is simplified. As a result, the conductor 201 provides a smaller resistance to the contacting unit 105 and the user can push the contacting unit 105 from the neutral position NP to the contacting position CP using a smaller force.

As illustrated in FIG. 3, when positioned in the contacting position CP, the conductor body 203 of the conductor 201 is by the blades 111 in the space 147 between the two blades 111 of the blade-structure 109 by the clamping force provided by the two blades 111.

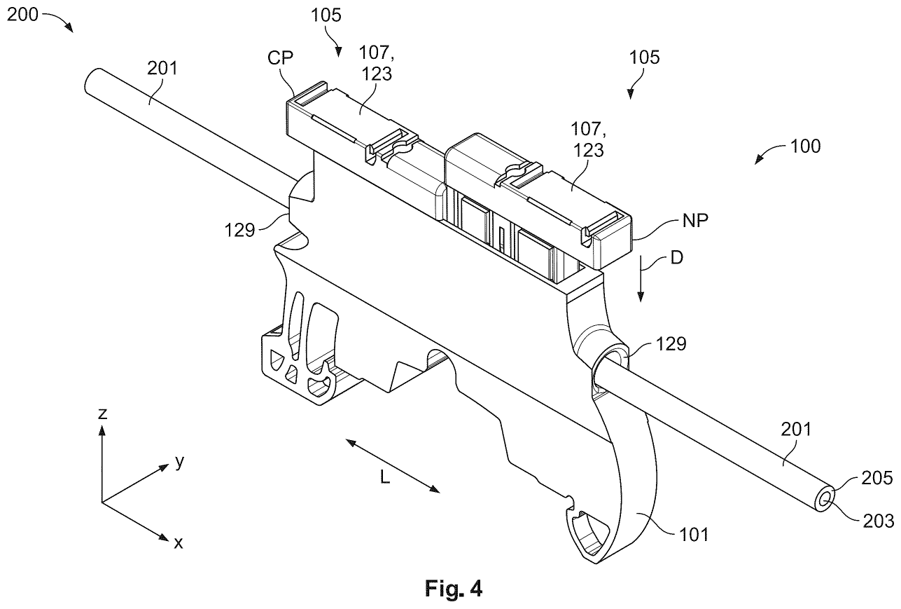

FIG. 4 shows a schematic illustration of the terminal system 200 with an electrical terminal 100 according to another embodiment.

In the shown embodiment, the electrical terminal 100 comprises two contacting units 105. The two contacting units 105 can be designed identical and the function of the contacting process corresponds to the process described with respect to FIGS. 1 to 3.

In the shown embodiment, the contacting units 105 are positioned on opposite sides of the electrical terminal 100 with respect of a longitudinal direction L of the terminal 100.

Via the two contacting units 105, two individual conductors 201 can be contacted individually. For this, the housing 101 of the terminal 100 comprises two insertion openings 129. Via the two insertion openings 129, the two individual conductors 201 can be inserted into the housing 101 and can be positioned in the insertion position IP, respectively.

By positioning each of the contacting units 105 in the contacting position CP, each of the two conductors 201 can be contacted. As an example, in FIG. 4, one of the two contacting units 105 is positioned in the neutral position NP and the other contacting unit 105 is positioned in the contacting position CP.

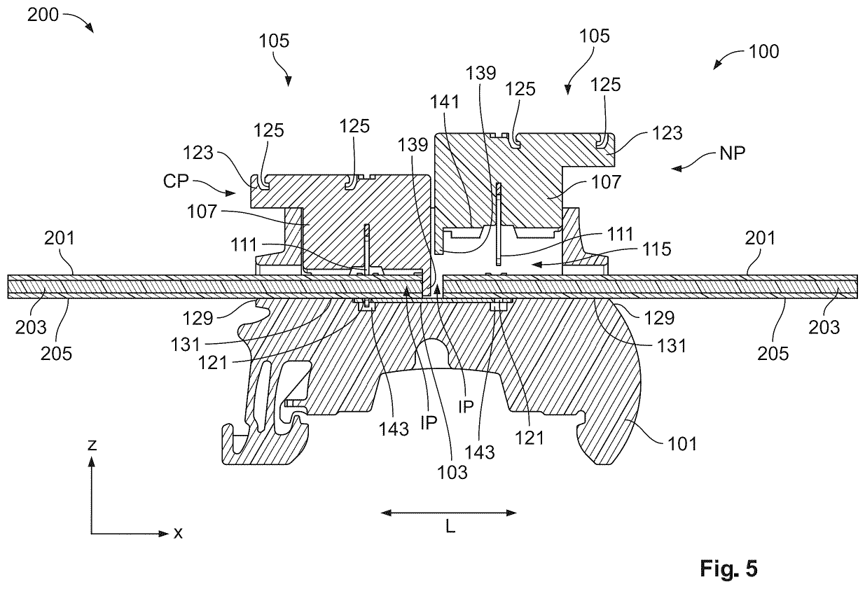

FIG. 5 shows a schematic sectional view of the terminal system 200 with an electrical terminal 100 according to another embodiment.

FIG. 5 is a sectional view of the electrical terminal 100 in the embodiment of FIG. 4.

As shown, each of the two contacting units 105 comprises a contacting body 107 with a blade-structure 111. The contacting units 105 are movable along the contacting direction D with respect to the housing 101.

In the shown embodiment, the two individual conductors 201 are inserted into the housing 101 via the two insertion openings 129 and are positioned in the insertion position IP in the accommodation space 115 between the blade-structures 109 and the contacting base 103, respectively.

At each of the insertion openings 129, the housing 101 comprises a positioning member 141, respectively. The positioning members 141 are designed as positioning faces, on which the inserted conductors 201 are positioned in the insertion position IP. The positioning members 141 are arranged to contact the conductor 201 mechanically and hold the conductor 201 when the contacting unit 105 is positioned in the contacting position CP.

To position the conductor 201 the positioning member 141 has a curved face in the shown embodiment.

In the shown embodiment, the contacting base 103 is platelike and extend along the longitudinal direction L of the terminal 100. Both conductors 201 are positioned partially on the same contacting base 103 when positioned in the insertion position IP. The platelike contacting base 103 comprises two contacting recesses 121 positioned over a recess space 143 of the housing 101, respectively.

The contacting recesses 121 are positioned on opposing ends with regard to longitudinal direction L of the platelike contacting base 103. The contacting recesses 121 of the contacting base 103 are positioning directly under the blade-structures of the contacting units 105 with regard to the contacting direction D, respectively.

By positioning the contacting units 105 in the contacting position CP, the tip portions 117 of the blades 111 of the blade-structures 109 protrude through the contacting recesses 121 of the contacting base 103 and extend into the recess spaces 143 of the housing 101, respectively. By positioning both of the contacting units 105 in the contacting position CP, both blade-structures 109 contact the same contacting base 103.

As a result, an electrical contact between the two individual conductors 201 can be provided by means of the contacting base 103.

In the shown embodiment, the two actuating members 123 of the two contacting bodies 107 of the two contacting units 105 comprise marker housing elements 125 for marking and/or identifying an electrical contact of a to be contacted wire.

In the shown embodiment, each of the contacting bodies 107 of the contacting units 105 comprises a movement stop 139. The movement stop 139 restricts a movement of the conductor 201, in particular an insertion movement, into the housing 101. In the shown embodiment, the two movement stops 139 are positioned adjacent to each other.

FIG. 6 shows a schematic illustration of the contacting units 105 of the electrical terminal 100 according to another embodiment.

FIG. 6 shows a perspective view of the two contacting units 105 and the contacting base 103 of the terminal 100 of FIG. 5.

FIG. 6 shows the platelike structure of the contacting base 103 with the two contacting recesses 121 arranged on two opposing sides of the platelike contacting base 103.

In the shown embodiment, the contacting bodies 107 of the contacting units 105 each show snap in grooves 135 of snap connection 127. Via the two parallel arranged snap in grooves 135, the respective contacting unit 105 can be positioned in the neutral position NP and the contacting position CP with respect to the housing 101. The snap in grooves 135 extend along the longitudinal direction L of the terminal 100 and therefore are perpendicular to the contacting direction D.

In this embodiment, the housing 101 comprises a snap in protrusion, not shown in any of the Figures, in order to snap in into the snap in grooves 135, when the respective contacting unit 105 is positioned either in the neutral position NP or the contacting position CP.

As an alternative embodiment, the respective snap in protrusion can be formed on the contacting body 107 of the contacting unit 105 and the respective snap in grooves 135 can be formed in the housing 101.

In the shown embodiments, the contacting bodies 107 of the contacting units 105 further comprise multiple guiding grooves 137. The housing 101 comprises respective protrusions, not shown in any of the Figures, to protrude into the guiding grooves 137. Via the guiding grooves 137 and the respective protrusions in the housing 101, the contacting direction D is defined and the respective contacting units 105 can be moved in a controlled manner between the neutral position NP and the contacting position CP.

In an alternative embodiment, the guiding grooves 137 can be formed in the housing 101 while the respective contacting bodies 107 of the contacting units 105 comprises respective protrusion elements.

In the shown embodiment, the contacting body 107 further comprises a positioning member 141. The positioning member 141 is arranged on the contacting body 107 opposite to the actuating member 123. Via the positioning member 141, the conductor 201 positioned in the insertion position IP can be held in the insertion position IP by the contacting body 107 of the respective contacting unit 105 when the contacting unit 105 is positioned in the contacting position CP.

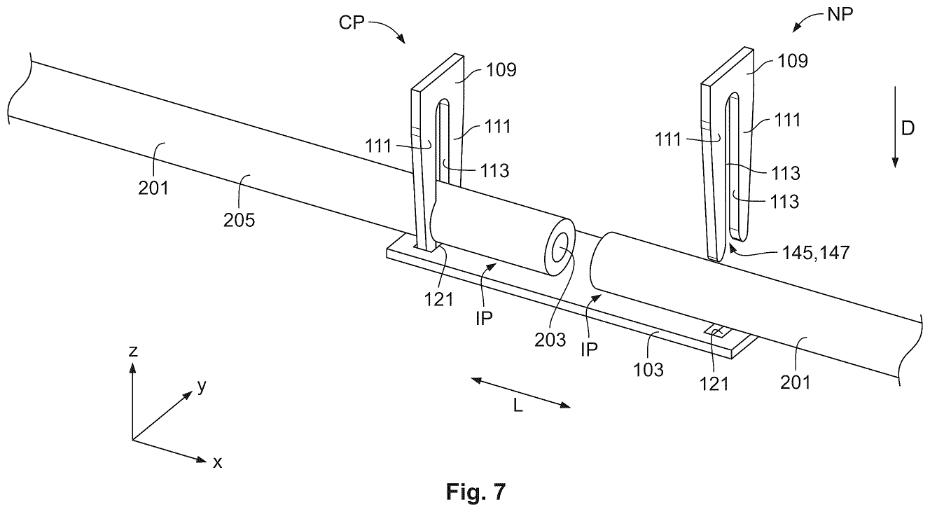

FIG. 7 shows another schematic illustration of the contacting units 105 of the electrical terminal 100 according to another embodiment.

FIG. 7 shows the blade-structures 109 of the two contacting units 105 and the contacting base 103 of the terminal 100 of FIG. 6. FIG. 7 shows the platelike structure of the contacting base 103 with the two contacting recesses 121 arranged on opposing sides of the platelike contacting base 103.

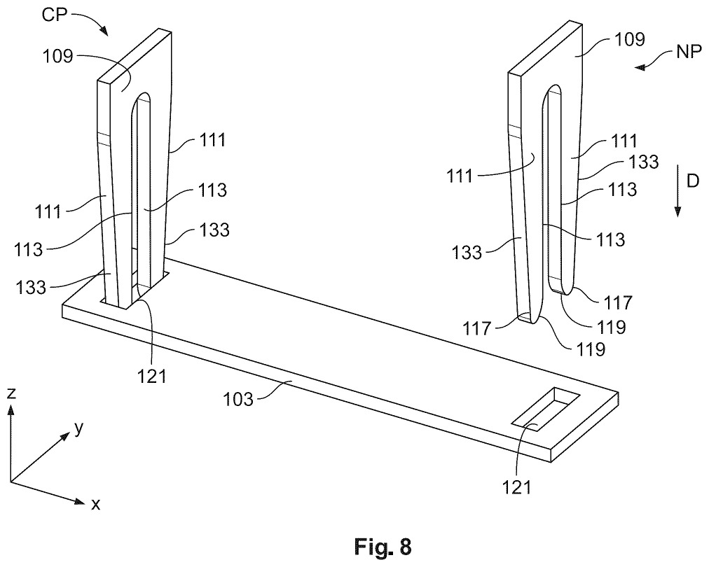

FIG. 8 shows another schematic illustration of the contacting units 105 of the electrical terminal 100 according to another embodiment.

FIG. 8 shows the blade-structures 109 and the contacting base 103 shown in FIG. 7, but without the illustrated conductors 201.

According to an embodiment, the blade-structures 111 and the contacting base 103 are manufactured out of metal materials by use of a punching process.

According to another embodiment, the housing 101 and the contacting bodies 107 of the contacting units 105 are manufactured from a plastic material.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Electrical terminal comprising:
a housing;
a contacting base positioned inside the housing; and
at least one contacting unit, wherein the contacting unit comprises a contacting body with a blade-structure comprising at least one blade with at least one cutting edge;
wherein the contacting unit is movable inside the housing along a contacting direction between an neutral position and a contacting position,
wherein the housing defines an accommodation space between the blade-structure and the conducting base,
wherein by moving the contacting unit from the neutral position to the contacting position a distance between the blade-structure and the contacting unit is reducible, and
wherein in the contacting position the blade-structure is arranged to contact the contacting base.

2. Terminal according to claim 1, wherein the blade-structure comprises a forklike structure with two blades and an opening facing the contacting unit, wherein each of the blades has a cutting edge, and wherein the cutting edges of the two blades are facing each other and/or are facing the contacting unit.

3. Terminal according to claim 2, wherein the two blades of the blade-structure are arranged to provide a clamping force.

4. Terminal according to claim 1, wherein a tip portion of the blade has a chamfered face.

5. Terminal according to claim 1, wherein the contacting base has a platelike shape with at least one contacting recess, and wherein in the contacting position the blade-structure protrudes through the recess and contacts the contacting base.

6. Terminal according to claim 1, wherein the contacting body comprises an actuating member protruding from the housing, and wherein the actuating member pushes the contacting unit from the neutral position to the contacting position.

7. Terminal according to claim 1, wherein the contacting body is made of a plastic material, and wherein the blade-structure and the contact base are made of a metal material by means of a punching process.

8. Terminal according to claim 1, wherein the contacting unit is lockable in the neutral position by a snap connection between the contacting unit and the housing.

9. Terminal according to claim 1, wherein the terminal comprises two contacting units, wherein each of the two contacting units comprises a blade-structure, and wherein in the contacting position each blade-structure of the two contacting units is arranged to contact the same contacting base.

10. Terminal according to claim 9, wherein the two contacting units are positioned opposite to each other.

11. Terminal according to claim 1, wherein the housing comprises at least one insertion opening with a guiding element.

12. Terminal according to claim 1, wherein the housing and/or the contacting base comprises an insertion stop defining an insertion distance between the insertion opening and the insertion stop.

13. Terminal system comprising:
an electrical terminal including a housing, a contacting base positioned inside the housing, and at least one contacting unit, wherein the contacting unit comprises a contacting body with a blade-structure comprising at least one blade with at least one cutting edge, the contacting unit being movable inside the housing along a contacting direction between an neutral position and a contacting position, the housing defines an accommodation space between the blade-structure and the conducting base, wherein, by moving the contacting unit from the neutral position to the contacting position, a distance between the blade-structure and the contacting unit is reducible, and wherein in the contacting position the blade-structure is arranged to contact the contacting base; and
at least one conductor, wherein the at least one conductor is inserted into the housing and positioned in the insertion position, wherein the contacting unit is positioned in the contacting position, wherein the conductor insulation of the conductor is cut and the conductor body of the conductor is contacted by the at least one cutting edge of the at least one edge of the blade-structure, wherein the contacting base is contacted by the blade-structure of the contacting unit, and wherein an electrical contact between the conductor body of the conductor and the contacting base is provided by means of the at least one blade of the blade-structure.

14. Terminal system according to claim 13, wherein a further conductor is inserted into the housing of the terminal and positioned adjacent to the contacting base of the terminal, wherein the further contacting unit is positioned in the contacting position, wherein the insulation of the further conductor is cut and the conductor body of the further conductor is contacted by the at least one cutting edge of the at least one blade of the blade-structure of the further contacting unit, wherein the contacting base is contacted by the at least one blade of the further contacting unit, wherein an electrical contact between the conductor body of the further conductor and the contacting base is provided by means of the at least one blade of the blade-structure of the further contacting unit, and wherein an electrical contact between the conductor and the further conductor is provided by means of the contacting base.

15. Method of assembling a terminal system, comprising:
providing an electrical terminal including a housing, a contacting base positioned inside the housing, and at least one contacting unit, wherein the contacting unit comprises a contacting body with a blade-structure comprising at least one blade with at least one cutting edge, the contacting unit being movable inside the housing along a contacting direction between an neutral position and a contacting position, the housing defines an accommodation space between the blade-structure and the conducting base, wherein, by moving the contacting unit from the neutral position to the contacting position, a distance between the blade-structure and the contacting unit is reducible, and wherein in the contacting position the blade-structure is arranged to contact the contacting base;
providing at least one conductor;
positioning the at least one contacting unit of the terminal in the neutral position;
inserting the at least one conductor into the housing of the electrical terminal and positioning an end portion of the conductor in the insertion position; and
pushing the at least one contacting unit from the neutral position to the contacting position, wherein in the contacting position the insulation of the conductor is cut by the at least one cutting edge of the at least one blade of the blade-structure of the contacting unit and the conductor body of the at least one conductor is contacted by the cutting edge of the blade of the blade-structure and the contacting base is contacted by the at least one blade of the blade-structure of the contacting unit.
